(19) United States
(12) Patent Application Publication
(10) Pub. No.: US 2023/0234176 A1
(43) Pub. Date: Jul. 27, 2023

(54) FLUID BALANCER AND MACHINE TOOL

(71) Applicant: FANUC CORPORATION, Minamitsuru-gun (JP)

(72) Inventors: Yuuya KAWASE, Minamitsuru-gun, Yamanashi-ken (JP); Hiroshi MINAMI, Minamitsuru-gun, Yamanashi-ken (JP)

(21) Appl. No.: 18/009,480

(22) PCT Filed: Jun. 10, 2021
(86) PCT No.: PCT/JP2021/022029

§ 371 Date: Dec. 9, 2022

(30) Foreign Application Priority Data
Jun. 16, 2020 (JP) 2020-103631

(51) Int. Cl. B23Q 1/38; F16M 11/24; F16M 11/42

(52) U.S. Cl. CPC B23Q 1/38; F16M 11/24; F16M 11/425

(57) ABSTRACT

A fluid balancer includes: a shaft; a cylinder; a base member which includes a through hole through which a shaft is inserted; a spacer which is provided between the shaft and the base member, and includes a plurality of grooves which are formed in a surface opposed to the shaft in the circumferential direction of the shaft at intervals and extend along the axial direction of the shaft and elastic support portion which supports the spacer with respect to the base member.

### TECHNICAL FIELD

The present invention relates to a fluid balancer and a machine tool that reduce, using compressed fluid, the weight of a slider provided movably along a guide shaft.

### BACKGROUND ART

A spindle head that supports a spindle to which a tool is detachably attached, a table for mounting a workpiece thereon, or the like is attached to a slider of a machine tool. Accordingly, the weight of the slider tends to increase. Therefore, a fluid balancer for reducing the weight of the slider may be provided in the machine tool.

For example, a machine tool disclosed in JP 2018-062037 A is provided with a fluid balancer (air balance mechanism) including a fixed shaft and a movable cylinder. The fixed shaft stands upright along a vertical axis. The movable cylinder moves relative to the fixed shaft. The movable cylinder is coupled to a spindle mechanism via a bridge frame, and moves up and down in conjunction with the spindle mechanism.

### SUMMARY OF THE INVENTION

However, the fixed shaft of JP 2018-062037 A may be fixed in a state of being inclined with respect to the vertical axis. When the fixed shaft is inclined even slightly with respect to the vertical axis, the gap formed between the outer circumferential surface of the fixed shaft and the inner circumferential surface of the movable cylinder and extending in the circumferential direction of the shaft becomes uneven. As a result, there is concern that the slider will not move smoothly. In particular, in a precision machine tool for machining a workpiece with relatively high machining accuracy, it is important to smoothly move the slider.

Therefore, an object of the present invention is to provide a fluid balancer and a machine tool capable of smoothly moving a slider.

According to a first aspect of the present invention, provided is a fluid balancer that reduces, using a compressed fluid, a weight of a slider provided movably along a guide shaft extending in a gravity direction and a direction opposite to the gravity direction, the fluid balancer comprising: a shaft provided along the guide shaft; a cylinder into which the shaft is inserted; a base member including a through hole through which the shaft is inserted, the cylinder being fixed to the base member; a spacer that is provided between the shaft and the base member and includes, on a surface thereof facing the shaft, a plurality of grooves extending along an axial direction of the shaft and formed at intervals in a circumferential direction of the shaft; and an elastic support portion having elasticity and configured to cause the spacer to be supported by the base member, wherein the shaft or the cylinder is coupled to the slider.

According to a second aspect of the present invention, provided is a machine tool comprising: the above-described fluid balancer; the guide shaft; the slider; and a motor configured to move the slider along the guide shaft.

According to the aspects of the present invention, it is possible to reduce the degree of non-uniformity of the gap between the spacer and the shaft. That is, even if the axis of the shaft is inclined from a predetermined specified position, the elastic support portion that supports the spacer is deformed by the compressed fluid flowing through the plurality of grooves formed in the spacer, whereby the spacer can move along the axis of the shaft. Therefore, the degree of non-uniformity of the gap between the spacer and the shaft can be reduced, and as a result, the slider can be moved smoothly.

### BRIEF DESCRIPTION OF DRAWINGS

FIG. 1 is a schematic view showing a machine tool;

FIG. 2 is a cross-sectional view taken along line II-II of FIG. 1;

FIG. 3 is a view showing a periphery including a spacer and an elastic support portion shown in FIG. 2;

FIG. 4 is a cross-sectional view showing a cross section of the spacer along the axial direction of a shaft;

FIG. 5 is a cross-sectional view showing a cross section of the spacer along the radial direction of the shaft;

FIG. 6 is a view showing a fluid balancer according to a first modification from the same viewpoint as FIG. 3;

FIG. 7 is a view showing a fluid balancer according to a second modification from the same viewpoint as FIG. 2; and

FIG. 8 is a view showing a fluid balancer according to a third modification from the same viewpoint as FIG. 2.

### DETAILED DESCRIPTION OF THE INVENTION

A preferred embodiment of the present invention will be described in detail below with reference to the accompanying drawings.

### Embodiment

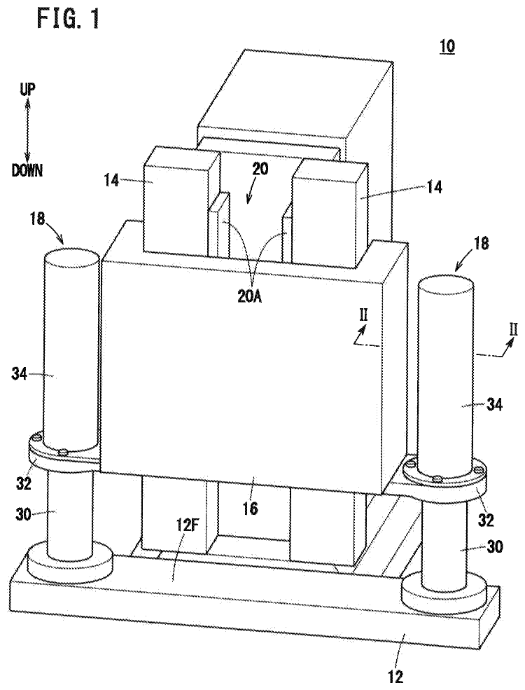

FIG. 1 is a schematic view showing a machine tool 10. In FIG. 1, an up-down direction is shown. The downward direction is a direction in which gravity acts, and the upward direction is a direction opposite to the direction in which gravity acts. The machine tool 10 includes a base 12, a guide shaft 14, a slider 16, and a fluid balancer 18.

The base 12 is a base on which the guide shaft 14 and the fluid balancer 18 are installed. The base 12 has an installation surface 12F. It should be noted that the installation surface 12F on which the guide shaft 14 is installed and the installation surface 12F on which the fluid balancer 18 is installed may be flush with each other or may be displaced from each other in the up-down direction. Further, the base 12 may include a first base and a second base. In this case, the first base and the second base are coupled to each other. The first base and the second base are separable from each other. The guide shaft 14 is installed on the first base. The fluid balancer 18 is installed on the second base.

The guide shaft 14 is a shaft that guides the slider 16. The guide shaft 14 is installed on the installation surface 12F of the base 12. The guide shaft 14 is fixed to the base 12 and extends in the up-down direction. The guide shaft 14 may be parallel to the vertical line or may be inclined with respect to the vertical line. The number of the guide shafts 14 may be one or more. When there are a plurality of guide shafts 14, the plurality of guide shafts 14 are provided in parallel. In the present embodiment, the number of the guide shafts 14 is two.

The slider 16 is movable along the guide shaft 14. The slider 16 moves upward or downward based on the power given from a motor 20. The motor 20 is not particularly limited as long as it gives power to the slider 16. The motor 20 may be a linear motor or a servo motor. In the present embodiment, the motor 20 is a linear motor. Magnets 20A of the motor 20 are provided one for each of the two guide shafts 14. The magnets 52A provided on the respective two guide shafts 14 face each other. Each of the magnets 52A is arranged along the guide shaft 14. A coil (not shown) of the motor 20 is disposed between the magnets 20A facing each other. The coil of the motor 20 is fixed to the slider 16. The slider 16 moves upward or downward by a magnetic field generated according to the drive current output to the coil of the motor 20.

It should be noted that a machine component such as a spindle head that rotatably supports a spindle to which a tool is detachably attached, or a table to which a workpiece is fixed, may be attached to the slider 16.

The fluid balancer 18 reduces the weight of the slider 16. When no machine component is attached to the slider 16, the weight of the slider 16 is the own weight of the slider 16. When a machine component is attached to the slider 16, the weight of the slider 16 is the sum of the weight of the slider 16 and the weight of the machine component.

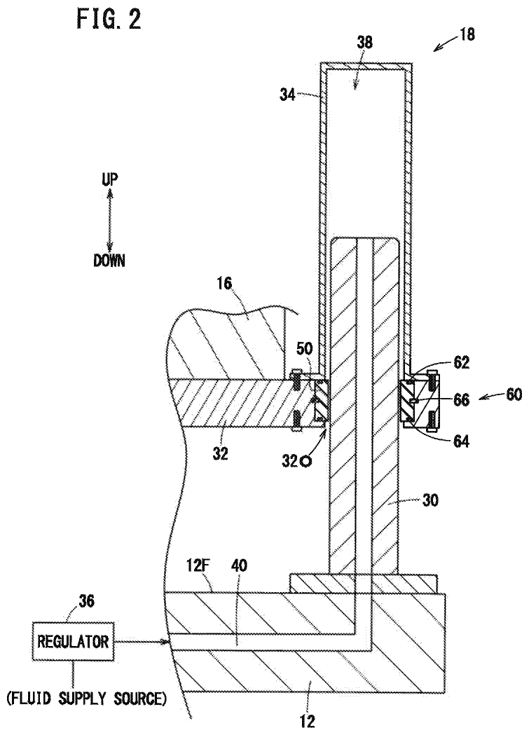

The number of the fluid balancers 18 may be one or more. In the present embodiment, the number of the fluid balancers 18 is two. The two guide shafts 14 are arranged between the two fluid balancers 18. Since the two fluid balancers 18 have the same structure, the structure of one of the fluid balancers 18 will be described below. FIG. 2 is a cross-sectional view taken along line II-II of FIG. 1. The fluid balancer 18 includes a shaft 30, a base member 32, a cylinder 34 and a regulator 36.

The shaft 30 is installed on the installation surface 12F of the base 12. The shaft 30 is fixed to the base 12. The shaft 30 is disposed away from the guide shaft 14 (see FIG. 1).

In the present embodiment, the base member 32 is fixed to the slider 16. For example, the base member 32 is fixed to the lower end portion of the slider 16. The base member 32 is formed in a plate shape and extends in a substantially horizontal direction toward the shaft 30. The base member 32 moves together with the slider 16. A through hole 320 is formed in the base member 32. The shaft 30 is inserted into the through hole 320.

The cylinder 34 is fixed to the base member 32. The cylinder 34 is disposed on one opening side of the through hole 320 formed in the base member 32. Since the base member 32 moves together with the slider 16, the cylinder 34 fixed to the base member 32 also moves together with the slider 16. The shaft 30 protruding from the one opening side of the through hole 320 is inserted into the cylinder 34. The cylinder 34 relatively moves away from the shaft 30 in response to the upward movement of the slider 16. The cylinder 34 relatively moves so as to approach the shaft 30 in response to the downward movement of the slider 16.

The regulator 36 regulates the pressure inside a fluid chamber 38. The fluid chamber 38 is formed between the shaft 30 and the cylinder 34. The regulator 36 may collectively adjust the pressures inside the fluid chambers 38 of the two fluid balancers 18. Alternatively, one regulator 36 may be provided for each of the two fluid balancers 18. The regulator 36 provided in each of the two fluid balancers 18 individually adjusts the pressure inside the fluid chamber 38 of the corresponding fluid balancer 18.

The regulator 36 adjusts the pressure inside the fluid chamber 38 by changing the flow rate or flow velocity of the compressed fluid flowing through a flow path 40 that allows the fluid chamber 38 and a fluid supply source to communicate with each other. The regulator 36 may change the flow rate or flow velocity of the compressed fluid flowing through the flow path 40 in accordance with the weight of the slider 16. Alternatively, the regulator 36 may change the flow rate or flow velocity of the compressed fluid flowing through the flow path 40 so that the drive current output to the motor 20 becomes a target value. In the example shown in FIG. 2, a part of the flow path 40 is formed in the shaft 30 and the base 12.

The slider 16 coupled to the cylinder 34 via the base member 32 is supported by the compressed fluid supplied from the fluid supply source to the fluid chamber 38. As a result, the weight of the slider 16 is reduced. A part of the compressed fluid supplied to the fluid chamber 38 is discharged from the through hole 320 of the base member 32 through a gap between the shaft 30 and the cylinder 34. Note that the compressed fluid is a fluid that has been compressed. Examples of the fluid include a gas such as air or nitrogen, or a liquid such as oil.

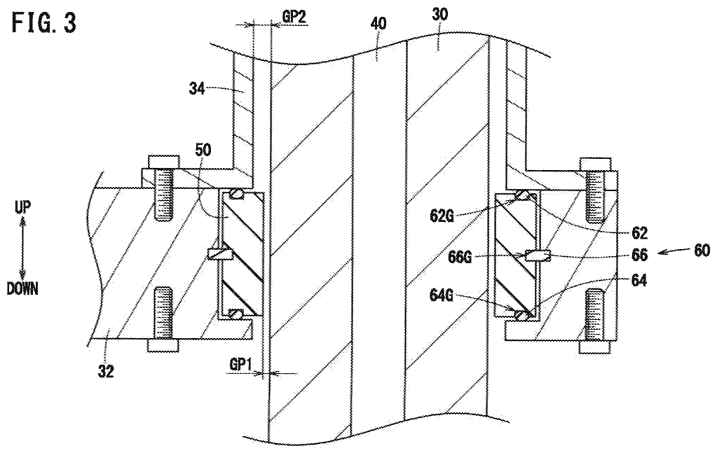

The fluid balancer 18 further includes a spacer 50 and an elastic support portion 60, in addition to the shaft 30, the base member 32, the cylinder 34, and the regulator 36. FIG. 3 is a view showing a periphery including the spacer 50 and the elastic support portion 60 shown in FIG. 2.

The spacer 50 is provided between the shaft 30 and the base member 32. The spacer 50 is supported on the base member 32 by the elastic support portion 60. The spacer 50 may be formed in an annular shape. FIGS. 2 and 3 show a case where the spacer 50 is formed in an annular shape.

A gap GP1 formed between the spacer 50 and the shaft 30 and extending along a direction intersecting the axial direction of the shaft 30 is narrower than a gap GP2 formed between the shaft 30 and the cylinder 34 and extending along the direction intersecting the axial direction of the shaft 30. That is, by providing the spacer 50, the gap with respect to the shaft 30 becomes narrower on the side where the compressed fluid is discharged. The gap GPI is preferably in a range of 5 μm to 10 μm.

The elastic support portion 60 has elasticity and causes the spacer 50 to be supported by the base member 32. The elastic support portion 60 includes a first seal member 62, a second seal member 64, and an elastic member 66. Specific examples of the first seal member 62 and the second seal member 64 include an O-ring. Specific examples of the elastic member 66 include an O-ring, a spring, and the like. The shape and material of the first seal member 62 and the second seal member 64 may be the same. Alternatively, at least one of the shape or the material of the first seal member 62 may be different from that of the second seal member 64.

The first seal member 62 is provided in a gap between the spacer 50 and the cylinder 34 located on one end side (upper side) of the shaft 30. A part of the first seal member 62 may be accommodated in an accommodation groove 62G. The accommodation groove 62G is formed on at least one of the surface of the spacer 50 or the surface of the cylinder 34. In a case where the accommodation groove 62G is formed on the surface of the spacer 50, the accommodation groove 62G is formed on the surface of the spacer 50 that faces the cylinder 34 (the surface of the spacer 50 on the one end side (upper side) of the shaft 30). In a case where the accommodation groove 62G is formed on the surface of the cylinder 34, the accommodation groove 62G is formed on the surface of the cylinder 34 that faces the spacer 50 (the surface of the cylinder 34 on the one end side (upper side) of the shaft 30). FIG. 3 shows a case where the accommodation groove 62G is formed on the surface of the spacer 50 on the one end side (upper side) of the shaft 30.

The second seal member 64 is provided in a gap between the spacer 50 and the base member 32 on another end side (lower side) of the shaft 30. A part of the second seal member 64 may be accommodated in an accommodation groove 64G. The accommodation groove 64G is formed on at least one of the surface of the spacer 50 or the surface of the base member 32. In a case where the accommodation groove 64G is formed on the surface of the spacer 50, the accommodation groove 64G is formed on the surface of the spacer 50 that faces the base member 32 (the surface of the spacer 50 on the other end side (lower side) of the shaft 30). In a case where the accommodation groove 64G is formed on the surface of the base member 32, the accommodation groove 64G is formed on the surface of the base member 32 that faces the spacer 50 (the surface of the base member 32 on the other end side (lower side) of the shaft 30). FIG. 3 shows a case where the accommodation groove 64G is formed on the surface of the spacer 50 on the other end side (lower side) of the shaft 30.

The elastic member 66 is provided in a gap between the spacer 50 and the base member 32. This gap extends along a direction intersecting the shaft 30. A part of the elastic member 66 may be accommodated in an accommodation groove 66G. The accommodation groove 66G is formed on at least one of the surface of the spacer 50 that faces the base member 32, or the surface of the base member 32 that faces the spacer 50. FIG. 3 shows a case where the accommodation groove 66G is formed on both the surface of the spacer 50 and the surface of the base member 32.

The number of the first seal members 62, the number of the second seal members 64, and the number of the elastic members 66 may be one or more, respectively. FIGS. 2 and 3 show a case where the number of the first seal members 62, the number of the second seal members 64, and the number of the elastic members 66 are one, respectively.

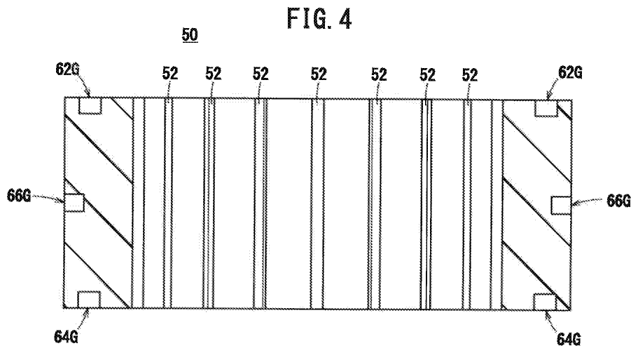

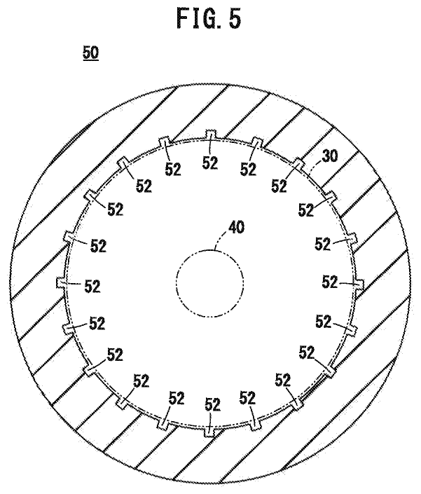

FIG. 4 is a cross-sectional view showing the cross section of the spacer 50 along the axial direction of the shaft 30. FIG. 5 is a cross-sectional view showing the cross section of the spacer 50 along the radial direction of the shaft 30. A plurality of grooves 52 are formed on the surface of the spacer 50 that faces the shaft 30. The plurality of grooves 52 are arranged at intervals in the circumferential direction of the shaft 30. Each of the plurality of grooves 52 extends along the axial direction of the shaft 30. The number of the grooves 52 is preferably in a range of 10 to 20. Further, the depth of the grooves 52 is preferably in a range of 100 μm to 200 μm. Furthermore, the width of the grooves 52 is preferably in a range of 50 μm to 100 μm.

In each of the plurality of grooves 52, a part of the compressed fluid supplied to the fluid chamber 38 (FIG. 2) flows from the upper side toward the lower side. When the compressed fluid flows through each of the plurality of grooves 52, pressure is applied to the spacer 50. As a result, the elastic support portion 60 that supports the spacer 50 is deformed. Therefore, when the axis of the shaft 30 is inclined with respect to the guide shaft 14, the elastic support portion 60 can move the spacer 50 along the axis. That is, the elastic support portion 60 moves the spacer 50 in the direction intersecting the axial direction of the shaft 30 by being deformed by the compressed fluid. Thus, the spacer 50 can move in accordance with the orientation of the shaft 30. Therefore, even if the axis of the shaft 30 is inclined with respect to the guide shaft 14, the degree of non-uniformity of the gap GP1 (FIG. 3) between the spacer 50 and the shaft 30 can be reduced. As a result, the slider 16 can be moved smoothly,

It should be noted that, when a part of the first seal member 62 of the elastic support portion 60 is accommodated in the accommodation groove 62G, it is possible to prevent the position of the first seal member 62 from being displaced due to the pressure being applied to the spacer 50. The same applies to a case where a part of the second seal member 64 of the elastic support portion 60 is accommodated in the accommodation groove 64G and a case where a part of the elastic member 66 of the elastic support portion 60 is accommodated in the accommodation groove 66G.

### Modifications

The above-described embodiment may be modified as follows.

### Modification 1

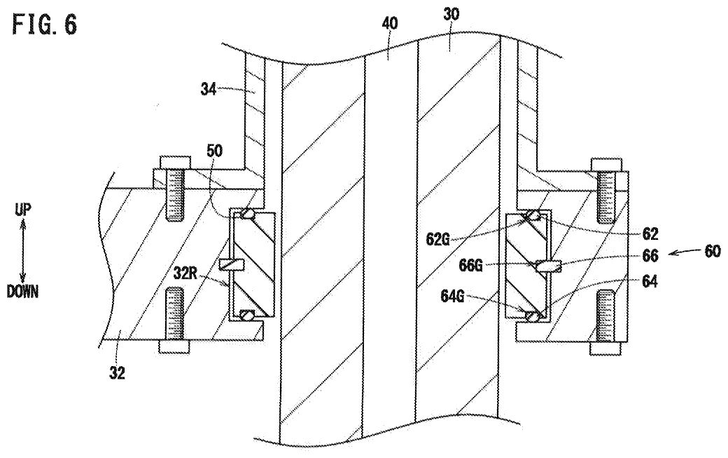

FIG. 6 is a view showing a fluid balancer 18 according to a first modification from the same viewpoint as FIG. 3. In FIG. 6, the same reference numerals are used to designate constituent elements that are the same as those described in the embodiment. Further, in the present modification, descriptions that are duplicative of those given in the embodiment will be omitted.

In the embodiment, the spacer 50 is disposed between the base member 32 and the cylinder 34. In contrast, in the present modification, the spacer 50 is disposed between the base member 32 on the upper side of a recessed portion 32R and the base member 32 on the lower side of the recessed portion 32R. The recessed portion 32R is provided on the surface of the base member 32 that faces the shaft 30. The recessed portion 32R is recessed in the direction intersecting the axial direction of the shaft 30.

Further, in the embodiment, the first seal member 62 is provided in the gap between the spacer 50 and the cylinder 34. In contrast, in the present modification, the first seal member 62 is provided in a gap between the spacer 50 and the base member 32.

In this manner, even when the arrangement of the spacer 50 and the first seal member 62 is changed, the elastic support portion 60 can move the spacer 50 along the axis of the shaft 30 with the compressed fluid, as in the embodiment.

### Modification 2

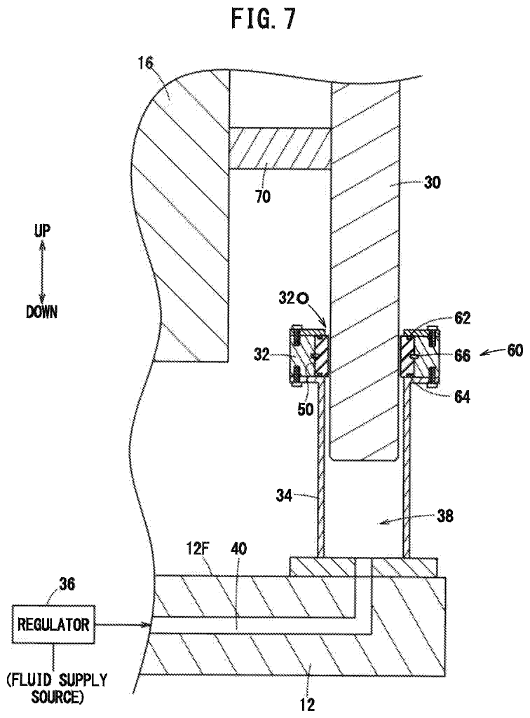

FIG. 7 is a view showing a fluid balancer 18 according to a second modification from the same viewpoint as FIG. 2. In. FIG. 7, the same reference numerals are used to designate constituent elements that are the same as those described in the embodiment. Further, in the present modification, descriptions that are duplicative of those given in the embodiment will be omitted.

In the embodiment, the shaft 30 is fixed to the base 12. In contrast, in the present modification, the cylinder 34 is fixed to the base 12. The flow path 40 is not formed in the shaft 30 of the present modification. In the present modification, the flow path 40 formed in the base 12 and the fluid chamber 38 inside the cylinder 34 fixed to the base 12 communicate with each other.

In the embodiment, the cylinder 34 is coupled to the slider 16 via the base member 32. In contrast, in the present modification, the shaft 30 is coupled to the slider 16 via a coupling member 70. When the shaft 30 is coupled to the slider 16 via the coupling member 70, the base member 32 is not in contact with the slider 16. In this case, the base member 32 may be formed in an annular shape. FIG. 7 shows a case where the base member 32 is formed in an annular shape.

Further, in the embodiment, the cylinder 34 is disposed above the spacer 50, and the first seal member 62 is provided between the spacer 50 and the cylinder 34. In contrast, in the present modification, the base member 32 is disposed above the spacer 50, and the first seal member 62 is provided between the spacer 50 and the base member 32. The first seal member 62 of the present modification is provided in a gap between the spacer 50 and the base member 32 on the upper end side of the shaft 30.

In the embodiment, the base member 32 is disposed below the spacer 50, and the second seal member 64 is provided between the spacer 50 and the base member 32. In contrast, in the present modification, the cylinder 34 is disposed below the spacer 50, and the second seal member 64 is provided between the spacer 50 and the cylinder 34. The second seal member 64 of the present modification is provided in a gap between the spacer 50 and the cylinder 34 on the lower end side of the shaft 30.

In this manner, in the present modification, the fluid balancer 18 is turned upside down from that in the embodiment. In the fluid balancer 18 of the present modification, the shaft 30 is coupled to the slider 16, and the shaft 30 relatively moves in accordance with the movement of the slider 16. Also in this case, as in the embodiment, the elastic support portion 60 can move the spacer 50 along the axis of the shaft 30 with the compressed fluid.

Although not illustrated, the recessed portion 32R of the first modification may be provided in the base member 32 of the present modification. In a case where the recessed portion 32R is provided in the base member 32 of the present modification, the first seal member 62 is provided in a gap between the spacer 50 and the base member 32 on the upper side of the recessed portion 32R. Further, the second seal member 64 is provided in a gap between the spacer 50 and the base member 32 on the lower side of the recessed portion 32R.

### Modification 3

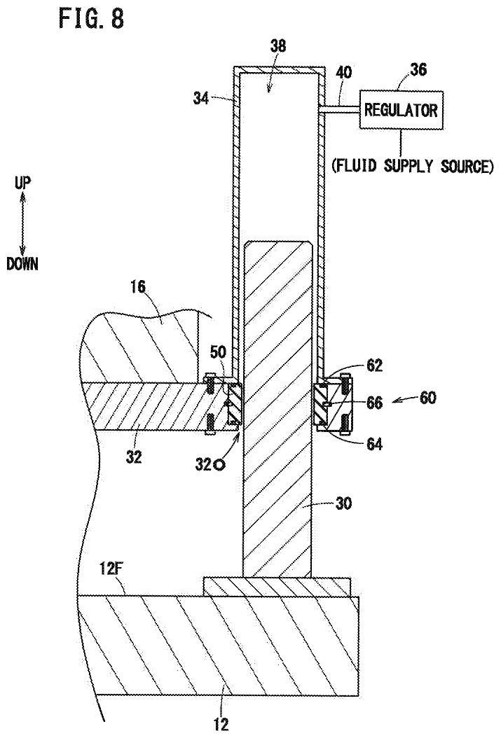

FIG. 8 is a view showing a fluid balancer 18 according to a third modification from the same viewpoint as FIG. 2. In FIG. 8, the same reference numerals are used to designate constituent elements that are the same as those described in the embodiment. Further, in the present modification, descriptions that are duplicative of those given in the embodiment will be omitted.

In the embodiment, the fluid supply source and the fluid chamber 38 are allowed to communicate with each other by the flow path 40 passing through the base 12 and the shaft 30. In contrast, in the present modification, the fluid supply source and the fluid chamber 38 are allowed to communicate with each other by the flow path 40 that does not pass through the base 12 and the shaft 30.

As described above, even when the flow path 40 does not pass through the base 12 and the shaft 30, the regulator 36 can adjust the pressure inside the fluid chamber 38 by changing the flow rate or flow velocity of the compressed fluid flowing through the flow path 40, as in the embodiment.

Although not illustrated, the flow path 40 of the second modification may not pass through the base 12 as in the present modification.

### Modification 4

The base member 32 of the embodiment may not be in contact with the slider 16 similarly to the base member 32 (FIG. 7) of the second modification. In a case where the base member 32 of the embodiment is not in contact with the slider 16, a coupling member that couples the slider 16 and the cylinder 34 is provided. Also in this case, as in the embodiment, the spacer 50 can be moved along the axis of the shaft 30 with the compressed fluid.

### Modification 5

The elastic member 66 of the embodiment or the second modification may be omitted. Even if the elastic member 66 is omitted, the first seal member 62 and the second seal member 64 enable the spacer 50 to move along the axis of the shaft 30 with the compressed fluid as in the embodiment. However, when the elastic member 66 is provided, the spacer 50 can be flexibly moved by the compressed fluid.

### Modification 6

The first seal member 62 and the second seal member 64 of the embodiment or the second modification may be omitted. In a case where the first seal member 62 and the second seal member 64 are omitted, the elastic member 66 has sealing properties such as an 0-ring. With this configuration, the elastic member 66 enables the spacer 50 to move along the axis of the shaft 30 with the compressed fluid while maintaining the sealing performance of the gap between the spacer 50 and the base member 32. However, when the first seal member 62 and the second seal member 64 are provided, the turbulence of the compressed fluid can be suppressed.

### Modification 7

The above-described embodiment and modifications may be arbitrarily combined as long as no technical inconsistency occurs.

### Inventions Obtained from the Embodiment

As inventions that can be grasped based on the above description, the first invention and the second invention will be described below.

### First Invention

The first invention is the fluid balancer (18) that reduces, using the compressed fluid, the weight of the slider (16) provided movably along the guide shaft (14) extending in a gravity direction and in a direction opposite to the gravity direction. The fluid balancer (18) includes: the shaft (30) provided along the guide shaft (14); the cylinder (34) into which the shaft (30) is inserted; the base member (32) including the through hole (320) through which the shaft (30) is inserted, the cylinder (34) being fixed to the base member (32); the spacer (50) provided between the shaft (30) and the base member (32), and including, on the surface thereof facing the shaft (30), the plurality of grooves (52) extending in the axial direction of the shaft (30) and formed at intervals in the circumferential direction of the shaft (30); and the elastic support portion (60) having elasticity and causing the spacer (50) to be supported by the base member (32). The shaft (30) or the cylinder (34) is coupled to the slider (16).

As a result, even if the axis of the shaft (30) is inclined from a predetermined specified position, the elastic support portion (60) supporting the spacer (50) is deformed by the compressed fluid flowing through the plurality of grooves (52) formed in the spacer (50), whereby the spacer (50) can move along the axis of the shaft (30). Therefore, the degree of non-uniformity of the gap (GP1) between the spacer (50) and the shaft (30) can be reduced, and as a result, the slider (16) can be moved smoothly.

The elastic support portion (60) may include the first seal member (62) provided in the gap that is formed by the spacer (50) and is located further in the direction opposite to the gravity direction than the spacer (50), and the second seal member (64) provided in the gap that is formed by the spacer (50) and is located further in the gravity direction than the spacer (50). As a result, it is possible to move the spacer (50) along the axis of the shaft (30) with the compressed fluid while suppressing turbulence of the compressed fluid flowing through the plurality of grooves (52) formed in the spacer (50).

The elastic support portion (60) may include the elastic member (66) provided in the gap that is formed between the spacer (50) and the base member (32) and extends along the direction intersecting the shaft (30). Thus, the spacer (50) can be moved along the axis of the shaft (30) by the compressed fluid. When the elastic member (66) is provided together with the first seal member (62) and the second seal member (64), the spacer (50) can be moved more flexibly by the compressed fluid than when the first seal member (62) and the second seal member (64) are not provided.

The shaft (30) may be fixed to the base (12), and the cylinder (34) may be coupled to the slider (16). As a result, the slider (16) coupled to the cylinder (34) can be supported using the compressed fluid supplied to the fluid chamber (38) between the cylinder (34) and the slider (16), and the weight of the slider (16) can be reduced.

The cylinder (34) may be coupled to the slider (16) via the base member (32). The number of components can be reduced as compared with a case where the cylinder (34) is coupled to the slider (16) via a member different from the base member (32).

The cylinder (34) may be fixed to the base (12), and the shaft (30) may be coupled to the slider (16). As a result, the slider (16) coupled to the shaft (30) can be supported using the compressed fluid supplied to the fluid chamber (38) between the cylinder (34) and the slider (16), and the weight of the slider (16) can be reduced.

### Second Invention

The second invention is the machine tool (10). The machine tool (10) includes the fluid balancer (18) described above, the guide shaft (14), the slider (16), and the motor (20) that moves the slider (16) along the guide shaft (14). Since the fluid balancer (18) is provided, the slider (16) can be moved smoothly.

The motor (20) may be a linear motor. Since a power transmission mechanism including a ball screw or the like is not required, the number of components can be reduced, and the slider (16) can be moved smoothly while suppressing vibration as compared with a case where the power transmission mechanism is provided.

1. A fluid balancer that reduces, using a compressed fluid, a weight of a slider provided movably along a guide shaft extending in a gravity direction and a direction opposite to the gravity direction, the fluid balancer comprising:
a shaft provided along the guide shaft;
a cylinder into which the shaft is inserted;
a base member including a through hole through which the shaft is inserted, the cylinder being fixed to the base member;
a spacer that is provided between the shaft and the base member and includes, on a surface thereof facing the shaft, a plurality of grooves extending along an axial direction of the shaft and formed at intervals in a circumferential direction of the shaft; and
an elastic support portion having elasticity and configured to cause the spacer to be supported by the base member, wherein
the shaft or the cylinder is coupled to the slider.

2. The fluid balancer according to claim 1, wherein
the elastic support portion includes:
a first seal member provided in a gap that is formed by the spacer and is located further in the direction opposite to the gravity direction than the spacer; and
a second seal member provided in a gap that is formed by the spacer and is located further in the gravity direction than the spacer.

3. The fluid balancer according to claim 1, wherein
the elastic support portion includes an elastic member provided in a gap that is formed between the spacer and the base member and extends along a direction intersecting the shaft.

4. The fluid balancer according to claim 1, wherein
the shaft is fixed to a base, and
the cylinder is coupled to the slider.

5. The fluid balancer according to claim 4, wherein
the cylinder is coupled to the slider via the base member.

6. The fluid balancer according to claim 1, wherein
the cylinder is fixed to a base, and
the shaft is coupled to the slider.

7. A machine tool comprising:
the fluid balancer according to claim 1;
the guide shaft;
the slider; and
a motor configured to move the slider along the guide shaft.

8. The machine tool according to claim 7, wherein
the motor is a linear motor.
